(19) United States
(12) Patent Application Publication
(10) Pub. No.: US 2014/0242284 A1
(43) Pub. Date: Aug. 28, 2014

(54) COATING APPARATUS AND COATING METHOD

(71) Applicant: Tokyo Ohka Kogyo Co., Ltd., Kawasaki-shi (JP)

(72) Inventors: Futoshi Shimai, Kawasaki-shi (JP); Akihiko Sato, Kawasaki-shi (JP); Kenji Maruyama, Kawasaki-shi (JP); Hiroshi Hosoda, Kawasaki-shi (JP); Masaki Chiba, Kawasaki-shi (JP)

(73) Assignee: Tokyo Ohka Kogyo Co., Ltd., Kawasaki-shi (JP)

(21) Appl. No.: 14/188,195

(22) Filed: Feb. 24, 2014

(30) Foreign Application Priority Data
Feb. 25, 2013 (JP) 2013-034836

(51) Int. Cl. B05B 3/04; B05B 9/00; B05D 1/02

(52) U.S. Cl. CPC B05B 3/0409; B05D 1/02; B05B 9/002
USPC 427/427; 118/302

(57) ABSTRACT

A coating apparatus including a coating nozzle configured to apply a coating liquid to a substrate, and a gas supply part configured to supply a temperature control gas which controls an ejection direction of the coating liquid to the substrate.

### FIELD OF THE INVENTION

The present invention relates to a coating apparatus and a coating method.

Priority is claimed on Japanese Patent Application No. 2013-034836, filed on Feb. 25, 2013, the content of which is incorporated herein by reference.

### DESCRIPTION OF THE RELATED ART

As a rotary atomization spray coating method, a method is known in which a temperature-control air is supplied to the ambience of the shaping air, so as to eliminate a temperature difference between the open air and the shaping air, and prevent generation of turbulence (for example, see patent document 1).

### DOCUMENTS OF RELATED ART

### Patent Documents

[Patent Document 1] Japanese Unexamined Patent Application, First Publication No. Hei 9-225350

### SUMMARY OF THE INVENTION

However, in the conventional method, the temperature control of the shaping air was not considered, and, for example, in the case where the temperature at which the substrate is treated became high, there was a possibility that a coating film could not be obtained.

The present invention takes the above circumstances into consideration, with an object of providing a coating apparatus and a coating method capable of conducting an excellent coating on a substrate at a high treatment temperature.

A coating apparatus according to one aspect of the present invention includes a coating nozzle configured to apply a coating liquid to a substrate, and a gas supply part configured to supply a temperature control gas which controls an ejection direction of the coating liquid to the substrate.

According to the coating apparatus of the present embodiment, the temperature of the coating liquid is controlled by the temperature control gas. Therefore, for example, even in the case where the substrate is maintained while controlling the temperature thereof, by decreasing the temperature difference between the substrate and the coating liquid, a coating film with a fine quality can be formed on the substrate.

In the coating apparatus, the gas supply part may be configured to supply an inert gas as the temperature control gas.

According to the above configuration, by virtue of supplying an inert gas, the ambience of the substrate can be maintained in a deoxygenated and dehydrated state.

In the coating apparatus, the inert gas may be a nitrogen gas.

According to the above configuration, the ambience of the substrate can be satisfactorily maintained in a deoxygenated and dehydrated state.

In the coating apparatus, the coating nozzle may be configured to apply a liquid material containing a metal and a solvent as the coating liquid to the substrate.

According to the above configuration, since the ambience of the substrate can be maintained in a deoxygenated and dehydrated state, the liquid material containing a metal and a solvent can be satisfactorily applied to the substrate.

In the coating apparatus, the coating nozzle may include a rotary atomization spray nozzle, and the temperature control gas may be a shaping air.

According to the above configuration, a coating film with a fine quality can be formed on the substrate by using the rotary atomization spray nozzle.

Furthermore, the gas supply part may be configured to supply, as the temperature control gas, a turbine air and a bearing air in the rotary atomization spray nozzle.

According to the above configuration, since the temperature of the turbine air and the bearing air supplied to the inside of the coating nozzle is controlled, the temperature of the shaping air inside the nozzle can be prevented from decreasing.

The coating apparatus may further include a temperature control unit configured to maintain the substrate in a temperature controlled state.

According to the above configuration, by virtue of controlling the temperature of the substrate, a coating treatment can be conducted on a substrate at a high treatment temperature.

A coating method according to one aspect of the present invention includes a coating step in which a coating liquid is applied from a coating nozzle to a face of a substrate, the coating liquid including a liquid material containing a metal and a solvent; and a temperature control gas being supplied to control an ejection direction of the coating liquid to the substrate in the coating step.

According to the coating method of the present embodiment, the temperature of the coating liquid is controlled by the temperature control gas. Therefore, for example, even in the case where the substrate is maintained in a state where the temperature of the substrate is controlled, by decreasing the temperature difference between the substrate and the coating liquid, a coating film with a fine quality can be formed on the substrate. Thus, by using a coating liquid including a liquid material containing a metal and a solvent, for example, a high quality light absorbing layer for a solar cell can be formed on a substrate.

In the coating method, in the coating step, the coating nozzle may be a rotary atomization spray nozzle.

According to the above configuration, a coating film with a fine quality can be formed on the substrate by using the rotary atomization spray nozzle.

In the coating method, in the coating step, the substrate may be maintained in a temperature controlled state by a temperature control unit.

According to the above configuration, by virtue of controlling the temperature of the substrate, a coating treatment can be conducted on a substrate at a high treatment temperature.

According to the present invention, an excellent coating can be conducted on a substrate at a high treatment temperature.

### BRIEF DESCRIPTION OF THE DRAWINGS

FIG. 1 is a diagram showing a configuration of a coating apparatus according to one embodiment.

FIG. 2 is a diagram showing a peripheral configuration of a coating nozzle.

FIG. 3 is a diagram showing a cross-sectional configuration of a coating nozzle.

FIG. 4 is a plan view showing a configuration of a coating apparatus.

FIG. 5 is a diagram showing a configuration of a suction part.

FIG. 6 is a diagram showing an operation of a coating apparatus.

### DETAILED DESCRIPTION OF THE INVENTION

Hereinafter, one embodiment of the present invention will be described with reference to the accompanying drawings.

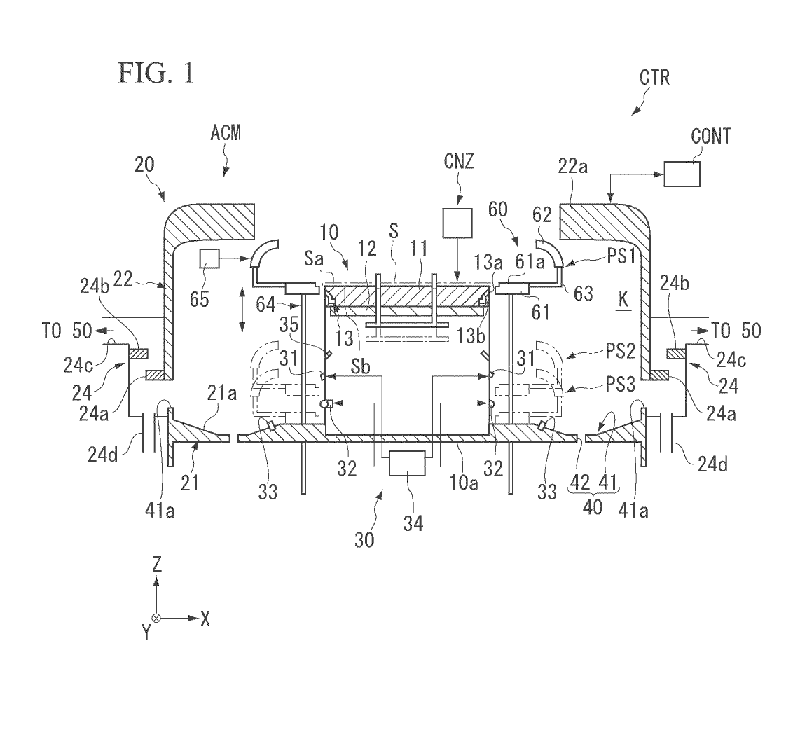

FIG. 1 is a schematic diagram showing a configuration of a coating apparatus CTR according to the present embodiment.

As shown in FIG. 1, the coating apparatus CTR has a substrate accommodation device ACM and a coating nozzle CNZ. The coating apparatus CTR applies a coating liquid to a substrate S accommodated in the substrate accommodation device ACM using the coating nozzle CNZ. The coating apparatus CTR is used by being disposed on a floor parallel to a horizontal plane. As the coating nozzle CNZ, for example, a rotary atomization spray nozzle is used.

In this embodiment, as the substrate S, for example, a plate-shaped member made of glass, resin, or the like may be used. As the substrate S, a wafer may be used. Further, in this embodiment, molybdenum is sputtered on the substrate S as a back electrode. Needless to say, any other electroconductive material may be used as a back electrode.

In this embodiment, as the coating liquid to be applied to the substrate S, for example, a liquid composition is used in which a metal material such as a combination of copper (Cu), indium (In), gallium (Ga), and selenium (Se) or a combination of copper (Cu), zinc (Zn), tin (Sn) and selenium (Se) is dispersed or dissolved in a solvent.

The liquid composition includes a metal material for forming a light absorbing layer (photoelectric conversion layer) of a CIGS solar cell or a compound semiconductor solar cell.

Further, the buffer layer may be formed of metal materials such as zinc (Zn), indium (In)and cadmium (Cd) dissolved in a solvent.

In the present embodiment, the liquid composition contains a substance for obtaining the grain size of a light absorbing layer of a CIGS solar cell or a compound semiconductor solar cell. Needless to say, as the liquid material, a liquid material in which another metal is dispersed or dissolved in a solution may be used.

The coating apparatus CTR is accommodated in a chamber (not shown). The chamber has, for example, a nitrogen gas supplied to the inside thereof, so as to maintain the atmosphere inside the chamber at a predetermined condition (e.g., a low oxygen concentration atmosphere, preferably an oxygen concentration of 1,000 ppm or less). Thus, the coating nozzle CNZ is capable of satisfactorily applying a liquid material containing a metal material (e.g., an indium solution) to a substrate S.

Herebelow, for describing the configuration of a coating apparatus CTR, an XYZ coordinate system is used. A direction on a horizontal plane is denoted the X direction, a direction parallel to the horizontal plane and perpendicular to the X direction is denoted the Y direction, and the vertical direction is denoted the Z direction. Further, the directions about the X axis, the Y axis and the Z axis are sometimes denoted θX direction, the 0Y direction and the 0Z direction, respectively.

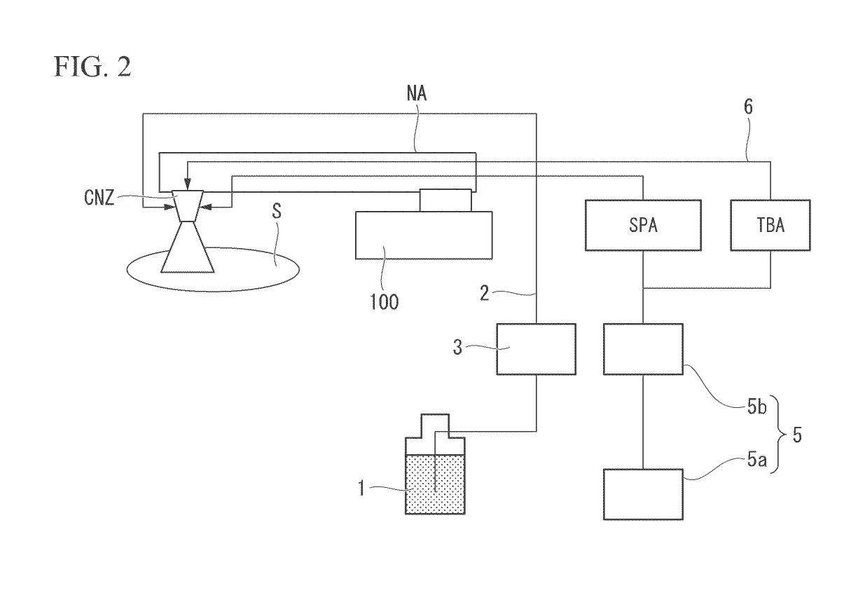

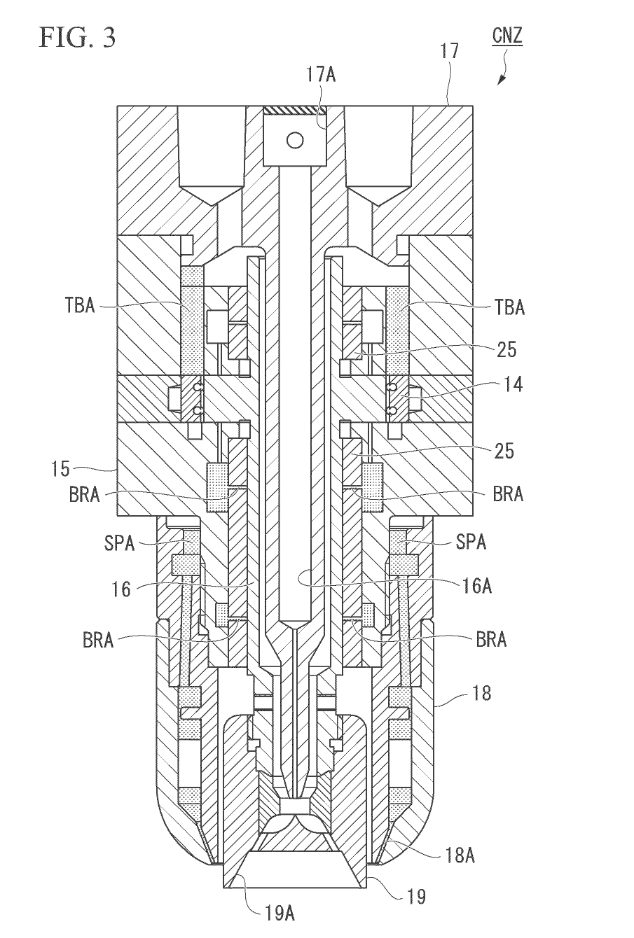

FIG. 2 is a diagram showing a peripheral configuration of the coating nozzle CNZ, and FIG. 3 is a diagram showing a cross-sectional configuration of the coating nozzle CNZ.

As shown in FIG. 2, the coating nozzle CNZ is connected to an actuating part 100 via a nozzle arm NA. The actuating part 100 moves the nozzle arm NA to transfer the coating nozzle CNZ attached to the tip of the actuating part 100 toward the substrate S accommodated in the substrate accommodation device ACM. The coating liquid is supplied to the coating nozzle CNZ from an accommodation tank 1 in which the coating liquid is accommodated via a supply path 2. Specifically, the coating liquid is supplied to the coating nozzle CNZ by a pump 3 provided on the supply path 2. The pump 3 may be a syringe pump.

A temperature control gas is supplied from a temperature control supply part 5 to the coating nozzle CNZ. The temperature control gas supply part 5 includes a gas supply part 5a and a heater 5b. The gas supply part 5a supplies an inert gas such as a nitrogen gas as the gas. The heater 5b is provided on the gas supply path between the gas supply part 5a and the coating nozzle CNZ. The temperature of the heater 5b is set in a range of 100 to 400° C. By such a configuration, the nitrogen gas supplied from the temperature control gas supply part 5 is heated to, for example, 30 to 70° C. The temperature control gas supply part 5 realizes a configuration in which an inert gas heated to 30 to 70° C. is supplied to the coating nozzle CNZ as a shaping air, a turbine air and a bearing air (which will be described later).

A turbine air for rotating a turbine (which will be described later) is supplied to the coating nozzle CNZ via an air supply path 6. In the present embodiment, the coating nozzle CNZ is constituted of a so-called rotary atomization spray nozzle.

As shown in FIG. 3, an air cup 19 is rotatably mounted on a lower end of the coating nozzle CNZ. The air cup 19 is provided with an ejection opening configured to jet the coating liquid. On an inner face 19A of the jetting opening of the air cup 19, a plurality of pores and a plurality of grooves inclined in the rotation direction are formed. The air cup 19 is attached to a tip of the turbine 14.

The turbine 14 is rotatably provided inside a spindle 15, and a main shaft 16 is accommodated inside the turbine 14. The main shaft 16 is supported on a pair of upper and lower bearings 25, 25. The turbine 14 is an air turbine in which a bearing air is present between the bearings 25, 25 and the main shaft 16 in a rotating state. When a high-pressure air is supplied to the spindle 15, the air functions as a bearing air such that the main shaft 16 is rotatably supported, thereby rotating the turbine 14. As a result, the air cup 19 attached to the tip of the turbine 14 is rotated at a high speed of 7,000 rpm at maximum.

In the main shaft 16, a liquid supply path 16A configured to supply a coating liquid is formed to penetrate along the shaft center. A coating liquid is supplied to the liquid supply path 16A by supplying a coating liquid to a supply port 17A of a back plate 17 which seals the upper end portion of the coating nozzle CNZ. By rotating the turbine 14 at a high speed, the coating liquid is atomized and sprayed from the air cup 19. In this manner, the coating liquid is miniaturized to a liquid droplet diameter of several mm, such that a precise coating film can be formed on the substrate S.

On the tip of the air cap 18 of the coating nozzle CNZ, a shaping air hole 18A configured to jet a carrier gas called a shaping air at a high speed is formed. By controlling the pressure of the shaping air (air flow of the shaping air) jetted from the shaping air hole 18A, the flying speed of the liquid droplet of the coating liquid can be controlled. In this manner, the liquid droplets of the coating liquid can be jetted at a speed of several tens of m/s.

In the present embodiment, the coating nozzle CNZ configured to apply a coating liquid uses a temperature control inert gas (nitrogen gas) controlled to about 30 to 70° C. as the shaping gas. Therefore, the coating liquid near the nozzle jet opening is controlled to a temperature of about 30 to 70° C.

In the present embodiment, the coating nozzle CNZ uses an inert temperature control gas (nitrogen gas) controlled to about 30 to 70° C. as the turbine air and the bearing air. The turbine air is an air for rotating the turbine 14, and the bearing air is an air supplied to the spindle 15 so as to function as an air bearing which rotatably supports the main shaft 16.

Therefore, the temperature decrease of the shaping gas can be suppressed, and the temperature of the coating liquid near the nozzle jet opening can be controlled to about 30 to 70° C.

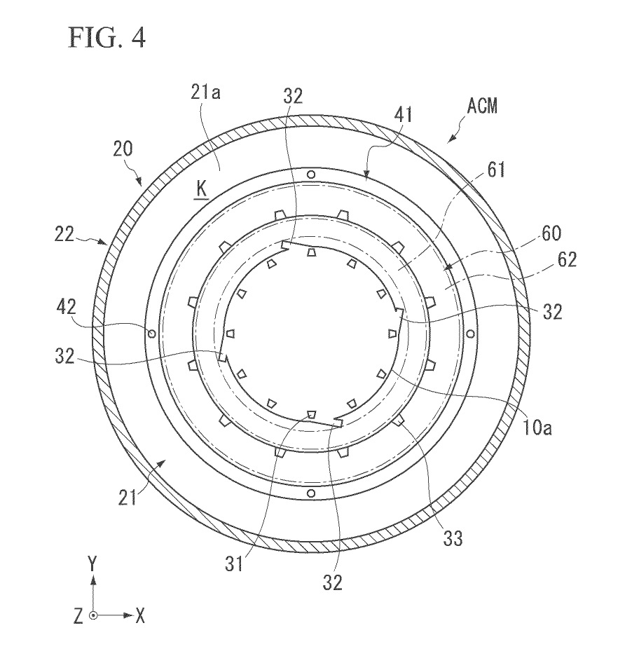

The substrate accommodation apparatus ACM has a substrate holding part 10, a cup 20, a recovery liquid supply part 30, a recovery liquid storing part 40, a suction part 50, a lift part 60 and a control part CONT. FIG. 4 is a diagram showing a configuration of the coating apparatus CTR, as viewed from the +Z direction. In FIG. 4, for easy understanding of the drawing, the configuration of the lift part 60 is indicated with a chain line.

As shown in FIG. 1 and FIG. 4, the substrate holding part 10 has an adsorption part 11, a heating part 12 and a gas jetting part 13. The adsorption part 11 is disposed at a central portion inside the cup 20, as viewed from the Z direction. The adsorption part 11 is configured to conduct a suction operation by a suction mechanism.

The face 11a of the adsorption part 11 on the +Z side holds the substrate S. Hereafter, the face 11a is referred to as holding face 11a. The holding face 11a is formed flatly to be in parallel to the XY plane. The adsorption part 11 is disposed on a base 10a.

The heating part (temperature control unit) 12 controls the temperature of the substrate S adsorbed on the adsorption part 11. The heating part 12 is mainly constituted of a hot plate (not shown). The operation of the hot plate is controllable by the control part CONT. The heating part 12 is attached to a face of the adsorption part 11 on the −Z side via a fixing member. The substrate holding part 10 may have any configuration capable of adjusting the temperature of the substrate S, and the position where the heating part 12 is attached is not limited to the above embodiment. For example, a configuration in which the heating part 12 is built inside the adsorption part 11 may be employed. Alternatively, the heating part 12 may be attached to a member other than the adsorption part 11.

The heating part 12 (hot plate), for example, heats the substrate S to a temperature of 200 to 250° C. The hot plate is set, for example, at a temperature near the melting point of the metal material contained in the coating liquid to be sprayed from the coating nozzle CNZ.

The gas jetting part 13 jets a gas (such as a nitrogen gas) to the ambience of the substrate S which is adsorbed on the adsorption part 11. The gas jetting part 13 has a jet opening 13a formed on the side of the adsorption part 11. The jet opening 13a is open outward from the adsorption part 11 in the radial direction. The jet opening 13a is connected to a gas supply source (not shown) via a gas flow path 13b.

The gas flow path 13b is inclined outward in the radial direction of the adsorption part 11 to the +Z side, relative to the horizontal direction. Therefore, the gas jetting part 13 forms a stream around the substrate S outward in the radial direction to the +Z side. By the stream, foreign matters can be prevented from approaching the back face of the substrate S.

The cup 20 is disposed to surround the substrate S held by the substrate holding part 10. The cup 20 has a bottom part 21 and a wall part 22. The cup 20 is formed in a circular shape as viewed in the Z direction. The bottom part 21 has a inclined portion 21a formed to extend to the −Z side. As shown in FIG. 4, the inclined portion 21a is formed in the shape of a circular ring along the outer peripheral face of the base 10a.

As shown in FIG. 1 and FIG. 4, the wall part 22 is formed in the shape of a cylinder and surrounds the substrate holding part 10. As shown in FIG. 1, a turn-back part 22a is formed on a +Z side end of the wall part 22. The turn-back part 22a is formed toward the central portion of the cup 20 as viewed in the Z direction.

The recovery liquid supply part 30 has first nozzles 31, second nozzles 32, washing liquid nozzles 33 and a supply source 34. The recovery liquid supply part 30 supplies a recovery liquid which collects foreign matters between the substrate S and the cup 20. Examples of the recovery liquid include pure water and the solvent of the liquid material supplied from the coating nozzle.

The first nozzles 31 are attached to the base 10a. The first nozzles 31 face outward from the base 10a. Specifically, the first nozzles 31 face the bottom part 21 of the cup 20. The first nozzles 31 wash the liquid receiving face 61a (described later) of the plate 61 provided on the lift part 60. The first nozzles 31 eject the recovery liquid to the bottom part 21. The first nozzles 31 are disposed at a substantially equal pitch in a circumference direction of the base 10a. Thus, the recovery liquid is evenly supplied along the periphery of the liquid receiving face 61a. The first nozzles 31 may be configured to jet air.

The second nozzles 32 are formed on the outer peripheral face of the base 10a. The second nozzles 32 face the bottom part 21 of the cup 20. The second nozzles 32 eject the recovery liquid to the bottom part 21. The second nozzles 32 face the circumference direction on the outer peripheral face of the base 10a. Specifically, as shown in FIG. 4, the second nozzles face the anti-clockwise direction. Thus, when the recovery liquid is ejected from the second nozzles 32, a stream of the recovery liquid is formed in the anti-clockwise direction on the bottom part 21. The second nozzles 32 are disposed at an equal pitch in a circumference direction of the bottom part 21. Thus, the speed of the stream of the recovery liquid becomes substantially even along the periphery of the bottom part 21.

The washing liquid nozzles 33 are disposed on the inclined part 21a of the bottom part 21. The washing liquid nozzles 33 face the wall part 22 of the cup 20. The washing liquid nozzles 33 eject a washing liquid to the wall part 22. Examples of the washing liquid include pure water, the solvent of the liquid material supplied from the coating nozzle, and also ozonated water.

The washing liquid nozzles 33 are adjustably provided such that the angle can be adjusted to incline in relation to the XY plane. Thus, the direction of the washing liquid nozzles 33 can be adjusted in the range of from the turn-back part 22a to the −Z side of the wall part 22. Further, by adjusting the angle of the washing liquid nozzles 33, the washing liquid can be supplied to the gas stream adjusting member 62 (described later) provided on the lift part 60, so as to wash the gas stream adjusting member 62. The washing liquid nozzles 33 are disposed at an equal pitch in a circumference direction of the bottom part 21. Thus, the washing liquid is evenly supplied along the periphery of the wall part 22.

The supply source 34 is disposed, for example, outside the cup 20. The supply source 34 supplies the recovery liquid to the first nozzles 31 and the second nozzles 32. By using a common supply source of the recovery liquid for the first nozzles 31 and the second nozzles 32, space can be saved as compared to the case where separate supply sources are used. Further, the burden of maintenance can be reduced. In addition, the supply source 34 supplies a washing liquid to the washing liquid nozzles 33. In the case where the same kind of liquid is used as the recovery liquid and the washing liquid, a common supply source can be used for the washing liquid nozzles 33.

Further, the supply source 34 supplies a clean dry air to air jet openings 35. The air jet openings 35 are plurally provided on the base 10a on the +Z side of the first nozzles 31. The plurality of air jet openings 35 are disposed at an equal pitch in a circumference direction of the base 10a. Each air jet opening 35 dries the liquid receiving face 61a (described later) of the plate 61 provided on the lift part 60. Each air jet opening 35 is directed to the bottom part 21. The air jet openings 35 may be configured to jet the recovery liquid.

The recovery liquid storing part 40 has a liquid receiving part 41 and a discharge part 42. The liquid receiving part 41 is formed at a portion including the bottom part 21 of the cup 20 and the −Z side portion of the wall part 22. The liquid receiving part 41 is configured to receive the recovery liquid ejected from the first nozzle 31 and the recovery liquid ejected from the second liquid nozzle 32. By maintaining the liquid receiving part 41 in a state of receiving the recovery liquid, the recovery liquid is stored in the recovery liquid storing part 40. The +Z side end 41a on the outer peripheral portion of the liquid receiving part 41 is disposed on the −Z side of the second nozzle 32.

The discharge part 42 is an opening formed on the bottom part 21 of the cup 20. The discharge part 42 is configured to discharge the recovery liquid stored in the liquid receiving part 41 outside the cup 20. The discharge part 42 is formed on the bottom face of the inclined part 21a. Thus, the recovery liquid received on the liquid receiving part 41 moves along the inclined part 21a to be reliably discharged. The discharge part 42 is connected to a discharge path (not shown).

The discharge part is provided with an open/close valve (not shown). By closing the open/close valve, the recovery liquid is stored in the recovery liquid storing part 40. By opening the open/close valve, the recovery liquid is discharged from the discharge part 42.

Further, on the outer peripheral side of the wall 22, a vent 24 is provided. The vent 24 discharges the gas in the space K surrounded by the cup 20, and functions to draw off the coating liquid adhered to the surface of the wall part 22. A configuration in which the vent 24 is not provided may be employed. The vent 24 has trap parts 24a and 24b. By the trap parts 24a and 24b, at least part of the gas component within the components discharged to the vent 24 is transferred to the opening 24c, and the liquid component is transferred to the opening 24d. The trap parts 24a and 24b have a function of liquefying part of the gas component. In such a case, the liquefied component is transferred to the opening 24d. The opening 24c of the vent 24 is connected to the suction part 50. Further, the opening 24d of the vent 24 is connected to a waste liquid recovery part (not shown) or the supply source 34.

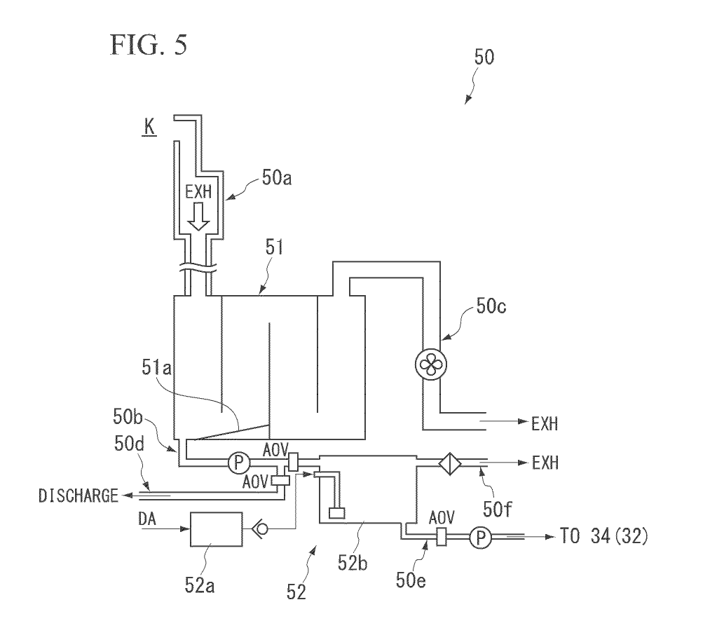

The suction part 50 is configured to suction the space K surrounded by the cup 20 via the vent 24. The suction part 50 is connected to the opening 24c of the vent 24. Further, the suction part 50 is connected to the space K via the opening 24c and the trap parts 24a and 24b. FIG. 5 is a diagram showing the configuration of the suction part 50.

As shown in FIG. 5, the suction part 50 has pipes 50a to 50f, a gas-liquid separation part 51 and an ozone cleaning part 52.

The pipe 50a is connected to the cup 20. The pipe 50a is connected to the wall part 22 from the outside thereof. The suction target present inside the cup 20 is suctioned outside the cup 20 via the pipe 50a. The pipe 50a is connected to the gas-liquid separation part 51.

The gas-liquid separation part 51 has a trap part 51a. The gas-liquid separation part 51 transfers the liquid component within the suction target suctioned form the inside of the cup 20 to the pipe 50b by the trap part 51a, and transfers the gas component to pipe 50c. The trap part 51a may have a function of liquefying part of the gas component, and may transfer the liquefied component to the pipe 50b. The pipe 50c is provided with a fan, and is configured to discharge the gas component transferred to the pipe 50c by a plant extractor.

The pipe 50b is connected to the ozone cleaning part 52. The ozone cleaning part 52 has an ozone generator 52a and a washing tank 52b. The ozone gas generated from the ozone generator 52a comes into contact with the liquid component by the diffuser pipe (not shown) provided on the washing tank 52b. By the ozone gas, the liquid component is separated into the solvent and the coating liquid. The ozone cleaning part 52 may not necessarily be provided.

The washing tank 52b transfers the liquid component after the washing to the pipe 50e. The pipe 50e is connected to the supply source 34. The liquid component transferred to the pipe 50e is transferred to the supply source 34 via the pipe 50e. The ozone gas used for the washing is discharged via the pipe 50f. The pipe 50b has a pipe 50d branched therefrom and connected thereto. The pipe 50d is connected to the waste liquid recovery part (not shown). Part of the liquid component transferred to the pipe 50b is discharged through the pipe 50d.

Returning to FIG. 1, the lift part 60 has a plate 61, a gas flow control member 62, a connecting member 63, a lift guide 64 and an actuating part 65.

As shown in FIG. 1 and FIG. 4, the plate 61 is formed in the shape of a circular ring surrounding the substrate S. The plate 61 has a flatly formed liquid receiving 61a. In the state shown in FIG. 1, the plate 61 is disposed at a first position PSI where a first face Sa of the substrate S held by the substrate holding part 10 on the +Z side is flush with (on the same plane as) the liquid receiving face 61a. The plate 61 is disposed such that a gap is formed between the plate 61 and the outer periphery of the substrate S held by the substrate holding part 10. The gas jet opening 13a of the gas jetting part 13 is directed to the gap from the second face Sb of the substrate S on the −Z side.

The gas flow control member 62 is configured to control the flow of the gas which has passed the outer periphery of the substrate S. The gas flow control member 62 is formed in the shape of a circular ring which surrounds the periphery of the substrate S. The gas flow control member 62 is disposed on the outside of the plate 61 so as to surround the plate 61. The gas flow control member 62 is integrally connected to the plate 61 by the connecting member 63. The gas flow control member 62 is curved so as to allow the gas which has passed the outer periphery of the substrate S to flow toward the suction part 50.

The lift guide 64 is provided in parallel to the Z direction. The plate 61 is provided to be movable along the lift guide 64 in the Z direction by the actuating operation of the actuating part 65. When the plate 61 is moved in the Z direction, the gas flow control part 62 integrally connected to the plate 61 is also movable in the Z direction.

The plate 61 is movable, for example, in the Z direction from a second position PS2 to a third position PS3. The second position PS2 is provided on the orbital of the recovery liquid jetted from the first nozzle 31. Therefore, in the case where the plate 61 is disposed at the second position PS2, by jetting the recovery liquid from the first nozzle 31, the plate 61 can be washed. The third position PS3 is the standby position of the plate 61.

The operation of the coating apparatus CTR having the above configuration will be explained.

Firstly, the substrate S is accommodated in the substrate accommodation apparatus ACM by a transport mechanism (not shown). The accommodated substrate S is mounted on the adsorption part 11. Then, the control part CONT adsorbs the substrate S on the adsorption part 11.

After adsorbing the substrate S, the control part CONT controls the temperature of the substrate S by the heating part 12, and jets a gas from the gas jetting part 13. The heating part 12, for example, heats the substrate S to 200 to 250° C. Further, the control part CONT starts the operation of the suction part 50. In addition, the control part CONT disposes the lift part 60 at the first position PS1. By disposing the lift part 60 at the first position PS1, the gas from the gas jetting part 13 passes the side portion of the substrate S and flows to the suction part 50 via the gas flow control part 62. Further, the liquid receiving face 61a of the plate 61 becomes flush with (is on the same plane as) the first face Sa of the substrate S.

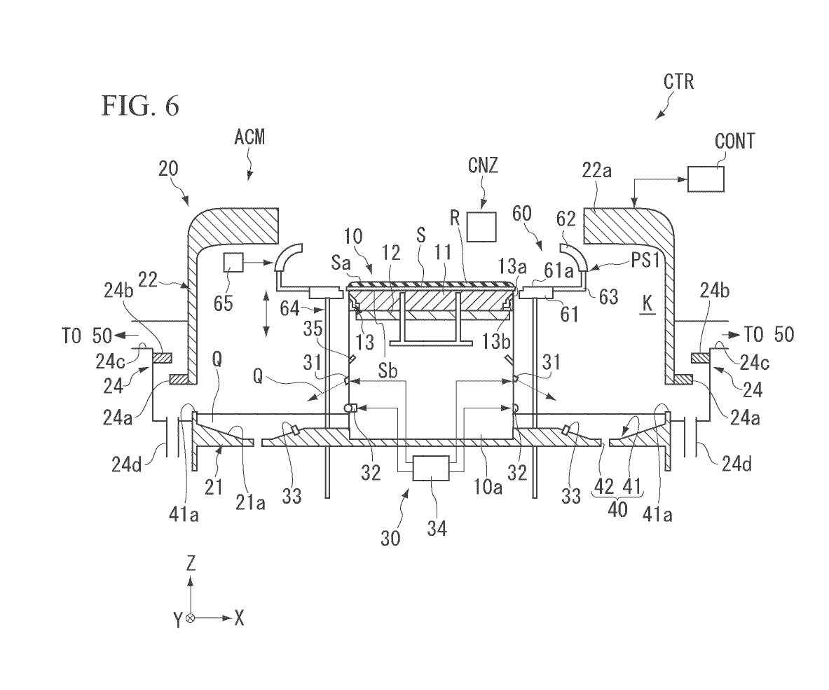

In this state, as shown in FIG. 6, the control part CONT ejects the recovery liquid Q from the first nozzle 31. As viewed in the Z direction, the recovery liquid Q is filled in the recovery liquid storing part 40 provided between substrate S and the wall part 22 of the cup 20. In this state, the control part CONT sprays the coating liquid on the first surface Sa of the substrate S using the coating nozzle CNZ. In the present embodiment, for example, the amount of the coating liquid to be sprayed from the coating nozzle CNZ is set to be 5 g/min.

In the present embodiment, the coating nozzle CNZ uses an inert temperature control gas heated to about 60 to 70° C. as a shaping air. Therefore, the coating liquid near the nozzle jet opening is controlled to a temperature of about 60 to 70° C. As a result, the temperature difference between the coating liquid sprayed onto the substrate S and the substrate S heat-controlled by the heating part 12 can be suppressed, as compared to the case where the temperature of the coating liquid to be sprayed onto the substrate S is not controlled.

According to the above configuration, the metal material contained in the coating liquid is instantly melt-solidified when the coating liquid adheres to the substrate S, such that a coating film R can be formed with a uniform film thickness on the substrate S. Thus, the coating apparatus CTR can form, on a substrate S, a coating film R containing uniform particles (metal material) which constitutes a highly reliable light absorbing layer or buffer layer for a solar cell.

In the case where a coating film R is formed using the coating nozzle CNZ, the coating liquid may scatter in the form of a mist. When such coating liquid in the form of a mist adheres to the cup 20, the cup 20 is stained. In contrast, according to the present embodiment, since the recovery liquid from the first nozzle 31 is supplied between the substrate S and the wall part 22 of the cup 20, even when the coating liquid in the form of a mist is scattered between the substrate S and the cup 20, the coating liquid can be recovered. Further, not only the coating liquid, but also dust and the like can also be collected. As a result, the apparatus conditions can be cleaned.

The technical scope of the present invention is not limited to the above-described embodiment, but may be appropriately modified into various forms without departing from the spirit of the present invention.

### DESCRIPTION OF REFERENCE CHARACTERS AND NUMERALS

CTR: coating apparatus, S: substrate, CNZ: coating nozzle, 12: heating part (temperature control unit), 5: temperature control gas supply part

What is claimed is:

1. A coating apparatus comprising:
a coating nozzle configured to apply a coating liquid to a substrate, and
a gas supply part configured to supply a temperature control gas which controls an ejection direction of the coating liquid to the substrate.

2. The coating apparatus according to claim 1, wherein the gas supply part is configured to supply an inert gas as the temperature control gas.

3. The coating apparatus according to claim 2, wherein the inert gas is a nitrogen gas.

4. The coating apparatus according to claim 2, wherein the coating nozzle is configured to apply a liquid material containing a metal and a solvent as the coating liquid to the substrate.

5. The coating apparatus according to claim 1, wherein the coating nozzle comprises a rotary atomization spray nozzle, and the temperature control gas is a shaping air.

6. The coating apparatus according to claim 5, wherein the gas supply part is configured to supply, as the temperature control gas, a turbine air and a bearing air in the rotary atomization spray nozzle.

7. The coating apparatus according to claim 1, further comprising a temperature control unit configured to maintain the substrate in a temperature controlled state.

8. A coating method comprising:
a coating step in which a coating liquid is applied from a coating nozzle to a face of a substrate, the coating liquid comprising a liquid material containing a metal and a solvent
a temperature control gas being supplied to control an ejection direction of the coating liquid to the substrate in the coating step.

9. The coating method according to claim 8, wherein, in the coating step, the coating nozzle is a rotary atomization spray nozzle.

10. The coating method according to claim 8, wherein, in the coating step, the substrate is maintained in a temperature controlled state by a temperature control unit.
